(19) United States
(12) Patent Application Publication
(10) Pub. No.: US 2011/0030360 A1
(43) Pub. Date: Feb. 10, 2011

(54) HYDRAULIC SYSTEM COMPRISING A HYDROSTATIC PISTON MACHINE

(76) Inventors: Alejandro Lopez Pamplona, Horb (DE); Bjoern Beuter, Hirrlingen (DE)

Correspondence Address: MICHAEL J. STRIKER, 103 EAST NECK ROAD, HUNTINGTON, NY, 11743, US

(21) Appl. No.: 12/849,293

(22) Filed: Aug. 3, 2010

(30) Foreign Application Priority Data
Aug. 6, 2009 (DE) 10 2009 036 346.7

(51) Int. Cl. F16D 33/00; F16D 31/00

(52) U.S. Cl. 60/329; 60/368

(57) ABSTRACT

A hydraulic system includes a hydrostatic piston machine having a plurality of valves that can be actuated using an actuator depending on the motion of the pistons and a control unit for activating the actuators. The switching points at which the valves are actuated are dependent on operating conditions, so that the expected functionality and the essential properties of the hydrostatic piston machine are ensured under different operating conditions.

### BACKGROUND OF THE INVENTION

The invention is directed to a hydraulic system.

Hydraulic systems of that type include a hydrostatic piston machine, the volumetric flow of which can be steplessly adjusted using a valve control. The hydrostatic piston machine includes a plurality of pistons that can move in a reciprocating manner in cylinders, each piston limiting a working space having a volume that changes with the stroke of a piston and that can be connected via a low-pressure valve to a low-pressure connection, and via a high-pressure valve to a high-pressure connection. The low-pressure valves, at the least, are actuated using an actuator which, in turn, is activated by a control unit. It must be possible to switch the valves highly dynamically so that the working space can be blocked very rapidly or released for through-flow. The functionality, the essential properties such as volumetric flow, pulsation, torque output, and leakage of the piston machine that includes such a valve are highly dependent on the closing points of the valves. The functionality of the unit is influenced considerably by varying operating conditions.

Since the operating conditions of the piston machine are not known, however, the exact switching point at which the valves must be actuated is difficult to find. Faulty states of the piston machine result, which are caused by inept actuation of the valves. For example, the cylinders may not be decompressed if the high-pressure valves are not deactivated at the right time.

By determining the exact switching points, it is possible to avoid supplying current to the valves unnecessarily and for an excessive duration. An additional electrical loss caused by supplying current for an excessive duration can thereby be prevented.

### SUMMARY OF THE INVENTION

The problem addressed by the invention is that of further developing a hydraulic system in a manner such that the expected functionality of the hydrostatic piston machine is ensured under different operating conditions.

In a hydraulic system according to the invention, the switching points at which the valves are actuated are dependent on operating conditions. Switching the valves in a manner that is controllable depending on the operating conditions ensures that the hydrostatic piston machine will function correctly. The valves achieve specific states at certain working points of the piston. Adapting the switching of the valves on the basis of the particular operating condition prevents faulty states of the piston machine from occurring and fundamentally improves efficiency.

The switching points are preferably dependent on the rotational speed of the drive shaft. The sensing of the rotational speed can be realized particularly easily using a velocity sensor. The exact dependencies of the switching points of the valves on the rotational speed of the drive shaft are determined on the basis of physical models of the system.

According to a particularly preferred embodiment of the present invention, the switching points for actuating the valves are dependent on temperature. The working conditions of a hydrostatic piston machine change with the temperature. At higher temperatures, the viscosity of the hydraulic fluid decreases, thereby making it more fluid and thinner. As a result, the valves can switch more rapidly, thereby enabling the switching points for actuating the valves to occur slightly later. Analogously, when viscosity is high, the switching point can occur slightly earlier. The temperature of the hydraulic fluid can be sensed in a simple, cost-effective manner using a measuring device that outputs signals to the control unit. The exact dependencies of the switching points of the valves on the temperature are determined on the basis of physical models of the system.

It can be advantageous to make the switching points dependent on the pressure in the high-pressure line or the low-pressure line. Pressure can then be measured using a pressure-measuring device. The pressure-measuring device can be realized easily and cost-effectively, and outputs signals to the control unit which, in turn, activate the valves as a function of pressure. The dependence of the switching time of the valves on pressure is determined on the basis of physical models of the system.

The switching points are preferably dependent on error functions. This means that targeted error detection and counteractive control can be realized by adaptively adjusting the switching points.

According to a particularly preferred embodiment of the present invention, the switching points for actuating the valves are determined using a calculation using physical models of the system. In so doing, the entire system, including the relevant properties, are simulated in a simulation model under varying operating conditions. The various operating-condition scenarios are investigated in the simulation to determine the optimal switching points for actuating the valves (offline calculation). The models can also be programmed in the control unit, and the switching points for the actual operating point can be calculated directly by the control unit (online calculation).

It can be advantageous to use an observer that is disposed in the control unit. It is then possible to determine the system state via observation on the basis of a few system variables detected using measurement technology in order to form a model. The model is used as the basis for calculating the exact switching times for actuating the valves. By comparing actual states with the expected states calculated by the observer, more exact statements regarding the switching point can be attained.

The state observer includes a model of the system from which the expected switching points are obtained, and a regulator that changes the switching points depending on the measurable variables.

### BRIEF DESCRIPTION OF THE DRAWINGS

An embodiment of a hydraulic system according to the present invention is shown in the drawings. The invention will now be explained in greater detail with reference to these drawings.

FIG. 1 shows a highly schematicized depiction to explain the operating method of a valve-controlled hydraulic piston machine having variable volumetric flow; and

FIG. 2 shows two graphs of piston stroke as a function of the angle of rotation of the rotational axis at operating conditions B_{A} and B_{B} with the switching points, which are based on static program maps, according to the prior art.

### DETAILED DESCRIPTION OF THE PREFERRED EMBODIMENTS

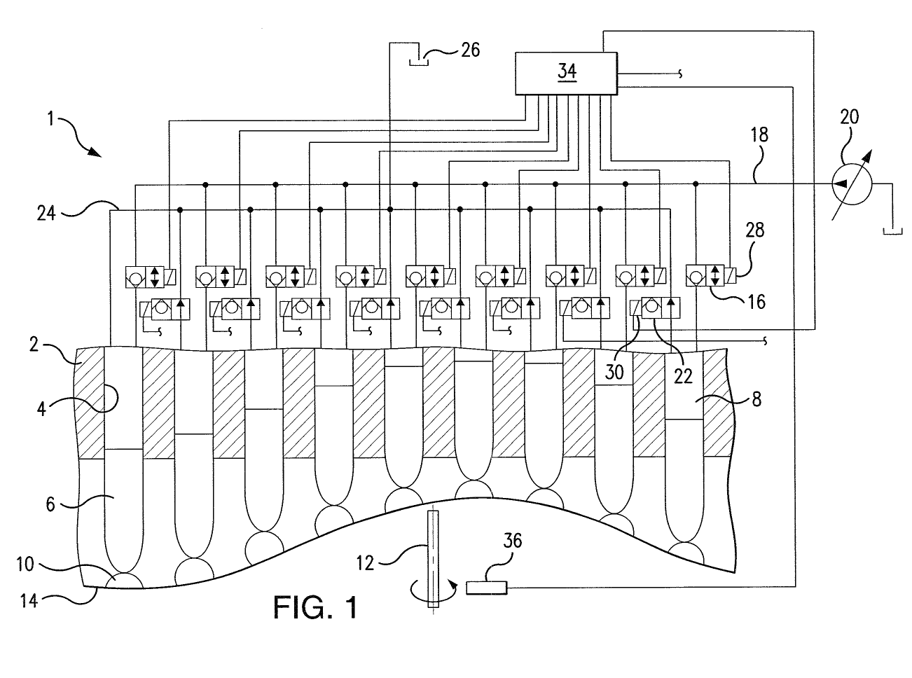

In the following, the operating method of a valve-controlled piston machine 1 having a digitally adjustable pump capacity/intake volume will be explained with reference to FIG. 1. These piston machines are also referred to Digital Displacement units (DDU). In the embodiment shown, the piston machine that is described is designed as an axial piston machine in swash plate design, wherein FIG. 1 shows a highly simplified variant. In the description that follows, piston machine 1 is described as a hydraulic motor, although the descriptions of the hydraulic motor basically likewise apply to a pump having a variable pump capacity.

According to the schematic depiction in FIG. 1, piston machine 1 includes a cylinder drum 2, in which a large number of cylinder bores 4 is formed, each of which contains an axially displaceable piston 6. Together with cylinder bore 4, each piston 6 limits a working space 8, the volume of which is independent of the stroke of piston 6. Each piston 6 bears via a piston shoe 10 against a slanted swash plate that is connected to an output shaft 12. Control curve 14 formed by the rotation of the awash plate is shown in the depiction in FIG. 1; control curve 14 shows how the piston stroke and, therefore, the volume of the particular working space are dependent on the angle of rotation. As shown on the right in FIG. 1, each working space 8 is connected via an inlet valve 16 to a supply line 18 that is common to all working spaces 8, and to which a system pressure or high pressure is applied. This high pressure can be created e.g. using a pump 20.

Moreover, each working space 8 is connected via a drain valve 22 to a drain line 24, which is likewise common to all working spaces 8, and which leads into a tank 26. In the embodiment shown, drain valves 22 and inlet valves 16 are designed as electrically releasable and blockable non-return valves. Inlet valve 16 is preloaded in its home position shown into a closed position via a not-shown spring, and can be moved into an opened position by applying current to a solenoid actuator 28, thereby allowing the pressure medium to flow out of inlet line 18 into particular working space 8. In its home position shown, drain valve 22 is preloaded into the opened position using a spring. By supplying current to solenoid actuator 30, drain valve 22 is moved into a blocking position in which the pressure medium cannot flow out of working space 8. Solenoid actuator 28, 30 is activated by a control unit which is used to set the different modes (full mode, partial mode, idle mode), and so the intake volume of hydraulic motor 1 is steplessly adjustable, wherein the pulsation can also be reduced to a minimum by activating valves 16, 22 in a suitable manner. In the embodiment shown, valves 16, 22 are activated depending on the rotational speed of output shaft 12, the rotational speed being detected using a rotational speed sensor 36 and reported via a signal line to control unit 34. In principle, other characteristic data such as the torque acting on output shaft 12, the intake volume of hydraulic motor 1, or the angle of rotation of the swash plate can be taken into account, of course, in the activation of valves 16, 22.

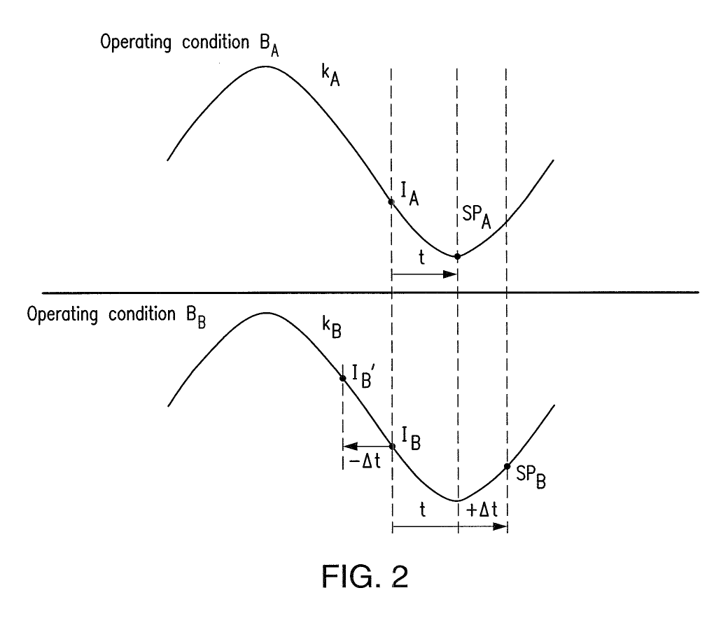

FIG. 2 shows two graphs of piston stroke as a function of the angle of rotation of the rotational axis at operating conditions A and B with resultant switching points SP_{A} and SP_{B}, which are determined based on static program maps. Piston stroke graph B corresponds to piston stroke graph A since it is based on the angle of rotation which remains the same at different operating conditions A and B.

In piston stroke graph A, given operating conditions B_{A}, switching point SP_{A} results from the setpoint assignment by the control unit in that activation of current supply I_{A} to valve A at time t, which corresponds to the time for magnetization plus the travel time of the valve, occurs earlier. Switching point SP_{A} for actuating valve A takes place at the desired instant.

If operating conditions B_{B} occur, however, time t increases by Δt due to the changed operating conditions B_{B}, and switching point SP_{B FOR} actuating valve B is delayed by Δt since current is supplied to valve I_{B} at the same time Analogously, current is supplied by Δt too soon if time t shortens.

In the hydraulic system according to the invention, switching point SP_{E}, at which valve B is actuated is dependent on operating condition B_{B}, and therefore current supply I_{B′} to valve B starts at a point in time which results from a physical model having operating condition B_{B}, and switching point SP_{B} starts at the desired point in time.

It will be understood that each of the elements described above, or two or more together, may also find a useful application in other types of constructions differing from the types described above.

While the invention has been illustrated and described as embodied in a device having a torque-limiting unit, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

### LIST OF REFERENCE NUMERALS

1 Piston machine
2 Cylinder drum
4 Cylinder bore
6 Piston
8 Working space
10 Piston shoe
12 Output shaft
14 Control curve
16 Inlet valve
18 Supply line
20 Pump
22 Drain valve
24 Drain line
26 Solenoid actuator
30 Solenoid actuator
34 Control unit
36 Rotational speed sensor
B_{A} Working condition A
B_{B} Working condition B
K_{A} Piston stroke graph A
K_{B} Piston stroke graph B
SP_{A} Switching point AA
SP_{B} Switching point B
I_{A} Current supplied to valve A
I_{B} Current supplied to valve B
I_{B′} Current supplied to valve B according to the invention
t Time for magnetization plus travel time of the valve
Δt Time for magnetization plus travel time of the valve

1. A hydraulic system, comprising:
a hydrostatic piston machine having a plurality of valves that are adapted to be actuated using an actuator depending on the motion of the pistons; and
a control unit to activate the actuators, wherein the valves are configured to be actuated at switching points, and wherein the switching point at which the valves are actuated are dependent on operating conditions.

2. The hydraulic system according to claim 1, wherein the switching points are dependent on a rotational speed of a drive shaft.

3. The hydraulic system according to claim 1, wherein the switching points are dependent on temperature.

4. The hydraulic system according to claim 1, wherein the switching points are dependent on pressure.

5. The hydraulic system according to claim 1, wherein the switching points are dependent on error functions.

6. The hydraulic system according to claim 1, wherein the switching points for actuating the valves are determined by performing an online or offline calculation using models of the control unit and/or the system.

7. The hydraulic system according to claim 1, further comprising an observer disposed in the control unit.

8. The hydraulic system according to claim 7, wherein the observer includes a model of a system from which the switching points are obtained and a regulator adapted to change the switching points depending on the measurable state variables.
